(19) United States
(12) Patent Application Publication
(10) Pub. No.: US 2007/0262587 A1
(43) Pub. Date: Nov. 15, 2007

(54) Automatic-locking-device

(76) Inventor: Roderick Duncan Anderson, Port Moody (CA)

Correspondence Address: Roderick Duncan Anderson, 837 Alexander Bay, Port Moody, BC, V3H 3R7, CA

(21) Appl. No.: 11/783,914

(22) Filed: Apr. 13, 2007

Related U.S. Application Data
(60) Provisional application No. 60/745,266, filed on Apr. 20, 2006.

(51) Int. Cl. E05B 65/52

(52) U.S. Cl. 292/28

(57) ABSTRACT

The Automatic Locking Device is a new and improved design for locking multiple containers together for transport by ship or rail. The device requires no labour once installed to lock or unlock multiply stacked containers.

### BACKGROUND OF THE INVENTION

This device pertains to the transportation of 20′, 40′, and 45′ containers from where products are manufactured and loaded through to the destination retail outlet.

When containers are loaded onto container ships, they require strapping to secure them to the ship. This device would reduce the amount of strapping on this part of transport and speed loading and unloading of the ship and also secure containers until their loaded on a train.

When loading onto a train, the process used today requires a lock to be installed on each corner which takes approximatly 6-8 minutes to lock 2 containers together.

With the volume of containers in North America today, any amount of time saving advantage will help reduce the backlog of goods and in turn make the process of getting products to market more seemless.

### BRIEF SUMMARY OF THE INVENTION

Device installs onto upper 4 corners of a 20′ or 40′ container to allow another 40′ or 45′ container to be stacked on top without manual labour and to be separated without manual labour.

Device has a security feature which does not allow container doors to be opened when in transport.

Device has a side leg which adds stability in transport.

Device has a latch which bends out of the way as top container is put on and then protrudes into the hole on the end corners of the bottom of top container to stop container from upward movement in transport.

Device can be turned upside down and be used as a means of stabilizing a stack of empty containers.

### BRIEF DESCIPTION OF THE SEVERAL VIEWS OF THE DRAWING

FIG. 1A depicts the top view of the Automatic Locking Device showing the latch and side arm. The latch pivots on a pin attached to the upper main body of device and then extends into top container end corner hole. The latch is made of cast steel and is 2″ thick, 5.5″ long and 2″ wide. 1A also shows how there is a 2″ gap to allow upper container to move over latch for removal from device. The side arm is made of 1″ cast steel and wraps around the outside edge of container and then along upper ledge of the backside of the corner. This gives device extra stability for both stacked containers during shipping. The side arm has 2 bolts—1 for security and the other for the arm to pivot upwards when not in use.

FIG. 1B depicts the side view of the automatic locking Device. This view is superimposed on top of what is the top and bottom corners of two stacked containers. This view shows how the latch comes to rest on inside of end hole in the upper container. The latch is spring loaded so it springs upwards to the point where it locks in place. On the other end it has a stop which does not let latch go any further upwards.

The main bolt is a 1″ bolt with the bolt head on inside of container corner along with bushing and back plate which attaches through main body of device and then to outside nut and cotter pin. The main body has a second opposing security bolt which can be removed to turn device upside down for storage position. The back plate is threaded for this bolt for easy removal.

FIG. 1C is the front view showing the 4 bolt positions, the latch and security leg which hangs down to block the opening of container doors during transport. This will cut down theft/vandalism.

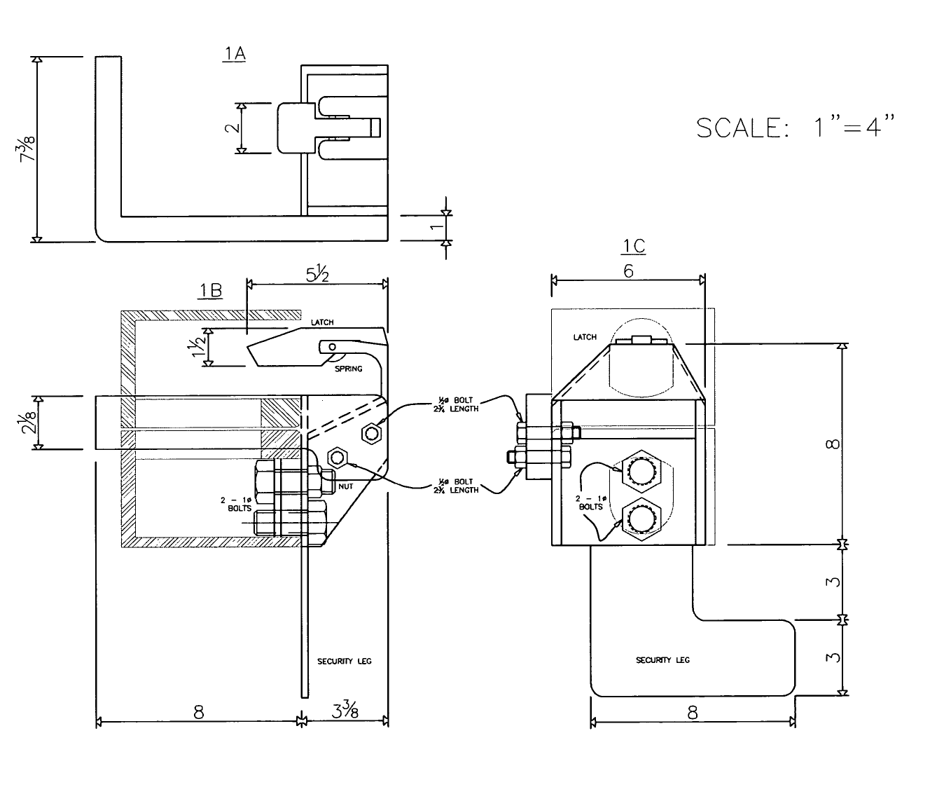

### DETAILED DESCRIPTION OF THE INVENTION

The Automatic Locking Device body is made 0.5″ steel welded together. The side arm and latch are made from cast steel. The side arm is attached to main body using opposing nuts and bolts. One bolt is for security. This device is then attached to a containers top corners using 2 nuts and bolts. The bolt is inserted through the backing plate and bushing and into the whole in the body of the device and then secured with a nut and cotter pin. The security bolt is then installed. After all 4 corners are installed on container, another container can then be placed on top. The latch mechanisms will flex downward as container bottom passes and then flex back up as whole in end of corners start. The container is now secured in place. To remove top container, simply lift up and slide to the left or right into the 2″ gap and one side will release. Then pull up on released side pull container towards released side to release other side.

When not in use, remove the security bolt on the side arm and remove security bolt on main body, then pull upwards on security arm and then turn whole device upside down. This will allow doors to open on container and also allow device to be used as an extra stabilizer when containers are just being stored.

1. The claim being made here is for the automatic locking and unlocking aspect of this device which allows 2-20′ or 40′ containers to be joined to either a 40′ or 45′ container on top and then separated using no manual labour. Locking is achieved by having flexable locking latches which move downward then snap up to lock container in place. Unlocking is achieved by having a space after the end stop or lip on each device of 2″ where the container can be moved up the latch and into the space to allow other side to release once it has cleared the lip.
